(19) United States
(12) Patent Application Publication
(10) Pub. No.: US 2026/0067338 A1
(43) Pub. Date: Mar. 5, 2026

(54) REMOTE COMPUTING SESSION PRELAUNCH

(71) Applicant: Citrix Systems, Inc., Fort Lauderdale, FL (US)

(72) Inventors: Sridharan Rajagopalan, Buford, GA (US); Mukund Ingale, Fort Lauderdale, FL (US); Hubert Divoux, Parkland, FL (US); Muhammad Dawood, Gerrards Cross (GB)

(21) Appl. No.: 18/816,815

(22) Filed: Aug. 27, 2024

(51) Int. Cl. H04L 65/1069; G06F 9/451; H04L 9/40; H04L 65/1089

(52) U.S. Cl. CPC H04L 65/1069; G06F 9/452; H04L 63/08; H04L 65/1089

(57) ABSTRACT

Methods and systems for a remote computing session prelaunch are described. A computing system may receive, from a computing device, a request to prelaunch a remote computing session. The computing system may receive a placeholder session file for the remote computing session. The computing system may initiate, using a launch service application hosted by the computing system, a prelaunch session. The prelaunch session may exist between internal components of the computing system but may represent a remote computing session between the computing system and a client device. The computing system may disconnect the prelaunch session until a trigger condition for establishing the remote computing session is identified. The computing system may establish, for a client device, the remote computing session based on the prelaunch session.

### FIELD

Aspects described herein generally relate to computer networking, remote computer access, virtualization, enterprise mobility management, and hardware and software related thereto. More specifically, one or more aspects described herein include a method for providing a remote computing session prelaunch.

### BACKGROUND

In some instances, devices (e.g., mobile phones, laptops, and/or other devices) may be used to prelaunch a remote computing session using a client application configured to connect to a server hosting the remote computing session (e.g., a virtual desktop client application). However, in current systems, prelaunching a remote computing session can be an inefficient and cumbersome process. For example, in current mobile operating systems), the client application used to prelaunch the remote computing session must remain in the foreground of the mobile device (e.g., a mobile phone, or the like) during session launch. Other devices, such as laptops or the like, may require that the virtual desktop client application remain running/active during the entirety of the prelaunch sequence. In some examples, it may be desirable to initiate a prelaunch when an employee enters a workplace (e.g., an office building, or the like), allowing the employee to connect to a remote computing session quickly when they arrive at a workstation, desk, or the like. In these examples, conventional methods of initiating a prelaunch may be inconvenient. For example, to initiate a prelaunch from a laptop computer, the employee would need to keep the laptop open and online during the entirety of the prelaunch.

In some instances, maintaining the client application in the foreground of the mobile device as described above may negatively impact the user experience and/or increase the battery usage. For example, it may take several minutes to prelaunch the remote computing session. Also or alternatively, an operating system of the mobile device may move the client application to a suspended state if the client application is not maintained in the foreground, causing a prelaunch sequence to be interrupted or canceled. As deployments of the remote computing session become increasingly complex, the time required to prelaunch the computing session (e.g., authenticating a connection, loading a user profile, and/or performing other actions to prelaunch the session) may also increase, further degrading the user experience. For example, for large institutions (e.g., financial institutions, or the like) that have complex deployments due to security measures and/or other requirements, the total time (and associated productivity) lost while waiting for a remote computing session prelaunch would be a product of the number of users who require remote connection

Conventional attempts to cure the above-described issues may introduce new problems. For example, a system utilizing a dedicated server to run a virtual desktop client application and perform a prelaunch may trigger a prelaunch when an employee scans a badge to enter a workplace. In these examples, however, scaling may become an issue. For example, an organization comprising thousands of employees may require a farm of servers, rather than a single dedicated server, increasing financial costs, energy use, and other increases in resource consumption.

Further, in conventional systems used by, for example, a large institution, certain times of day may increase the time spent waiting for a prelaunch. For example, there may be peak times (e.g., a start time associated with a standard work day, and/or other times at which a large percentage of the employees of an institution require a session prelaunch) during the day during with the duration of a prelaunch may increase due to the need for a virtualization system to scale up to meet the demand, and/or based on the maximum availability of computing resources at those peak times.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

As discussed above, conventional systems require that a prelaunch session be established with the specific server associated with a user of a mobile device. Launching remote computing sessions using these methods may be complicated and time-consuming. Thus, it may be important to provide improved methods for a remote computing session prelaunch as described herein.

To overcome limitations in the prior art described above, and to overcome other limitations that will be apparent upon reading and understanding the present specification, aspects described herein are directed towards improved methods for proving a remote computing session prelaunch.

In one or more instances, a computing system having one or more processors and memory storing computer-readable instructions that, when executed by the one or more processors, cause the computing system to receive, via a computing device, a request to prelaunch a remote computing session. The computing system may receive a placeholder session file for the remote computing session. The computing system may initiate, using a launch service application, a prelaunch session corresponding to the remote computing session. The computing system may disconnect the prelaunch session. The computing system may identify that a trigger condition for establishing the remote computing session has been satisfied. The computing system may establish, for a client device and based on the prelaunch session, the remote computing session.

In one or more arrangements, the computing system may generate, based on stored user information, a local user context. The computing system may initiate, based on the local user context, a utility remote computing session using the launch service application and a loopback connection to the computing system. The computing system may download, via the utility remote computing session, user information corresponding to the computing device. The computing system may, based on the user information corresponding to the computing device, the placeholder session file. Initiating the prelaunch session may be based on the utility remote computing session. In one or more examples, the local user context may include spoofed client device information. In one or more arrangements, the computing system may output, to the client device and based on establishing the remote computing session, a remote desktop display.

In one or more examples, the computing system may authenticate, after disconnecting the prelaunch session and prior to establishing the remote computing session, the client device. In one or more arrangements, the launch service application may be configured to initiate the prelaunch session based on user information corresponding to the computing device. In one or more examples, the launch service application may be configured to initiate the prelaunch session based on the placeholder session file. In one or more arrangements, initiating the prelaunch session may include loading one or more profiles corresponding to a user of the computing device. In one or more examples, initiating the prelaunch session may include prelaunching one or more applications identified by the request to prelaunch the remote computing session. In one or more arrangements, identifying that the trigger condition for establishing the remote computing session has been satisfied may include identifying that a predetermined amount of time after initiating the prelaunch session has been met or exceeded. In one or more examples, identifying that the trigger condition for establishing the remote computing session has been satisfied may include identifying that the second device is located within a threshold proximity of the client device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an illustrative computing environment for performing a remote computing session prelaunch in accordance with one or more illustrative aspects described herein.

FIGS. 6A-6B depict an illustrative event sequence for performing a remote computing session prelaunch in accordance with one or more illustrative aspects described herein.

FIG. 7 depicts an illustrative method for performing a remote computing session prelaunch using a prelaunch orchestrator service in accordance with one or more illustrative aspects described herein.

FIG. 8 depicts an illustrative diagram for performing a remote computing session prelaunch using a lean virtual desktop application in accordance with one or more illustrative aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards a remote computing session prelaunch. For example, remote computing sessions may be established between a client device (e.g., a client device running a virtual desktop client application) and a server hosting a remote computing service (e.g., a virtual desktop agent (VDA) host server, or the like). A user, associated with the client device, of a virtual desktop client application may be required to authenticate to the server from the client device to launch a session. Launching a session may comprise authenticating, from the client device and using a control platform, such as Citrix Cloud developed by Citrix Systems, Inc. of Ft. Lauderdale, Florida, the user, receiving a list of virtual desktops (e.g., from the control platform) to use for the session, requesting the launch of the session on a virtual desktop, authenticating the user on the VDA (e.g., using a single-sign on (SSO) or the like), loading a user profile, preparing one or more resources corresponding to the session, and/or other processes that may consume time and resources (e.g., CPU usage, network bandwidth, and/or other resources).

Mobile devices may, in some examples, be used to prelaunch a remote computing session in advance. For example, a user may use a dedicated mobile device hosting a virtual desktop client application to prelaunch a remoting computing session for a client device (e.g., a laptop, desktop, or the like). However, conventional systems require that a user of a dedicated client device be authenticated to the control platform (e.g., Citrix Cloud) for the prelaunch to be initiated. Additionally, the virtual desktop client application (used for prelaunch) may require that the application remain in the foreground of the mobile device for the duration of the session launch, which may obscure other applications and/or elements of the mobile device, increase battery usage of the mobile device, and/or otherwise negatively impact the user experience.

The server and/or computing systems hosting remote computing sessions may possess advantages over mobile devices and/or other client devices such as increased processing power, increased memory storage, and/or other advantages that may facilitate prelaunching a remote computing session. Additionally, some providers of remote computing services may operate multiple servers and/or computing systems that might be used to distribute requests to prelaunch remote computing sessions across a plurality of services based on available resources. These advantages may, if utilized, result in greater efficiency and conservation of resources when prelaunching remote computing sessions. However, no method of prelaunching a remote computing session without requiring the virtual desktop client application to be maintained at the foreground of the mobile device and/or client device currently exists in conventional systems.

As described herein, in some examples a remote computing session may be prelaunched without using a mobile device. For example, a prelaunch may be initiated based on an employee swiping a badge at a workplace. In these examples, however, scaling issues would cause different, but not less important, inconveniences to those described with respect to prelaunching using a mobile device. For example, a farm of servers may be required to effectively scale prelaunching using a dedicated server for organizations with hundreds or thousands of employees.

With the growth of cloud adoption, the need for a method of prelaunching a remote computing session that eliminates the need for a virtual desktop client application that remains in the foreground of a device for the duration of the prelaunch and distributes the workload from a mobile device or a dedicated server is becoming increasingly prominent. Accordingly, described herein is an improved method for providing a remote computing session prelaunch.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

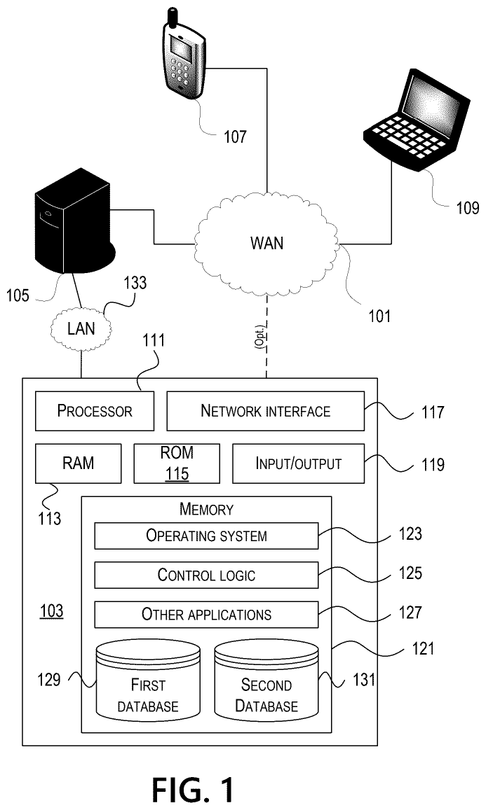

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data-attributable to a single entity-which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

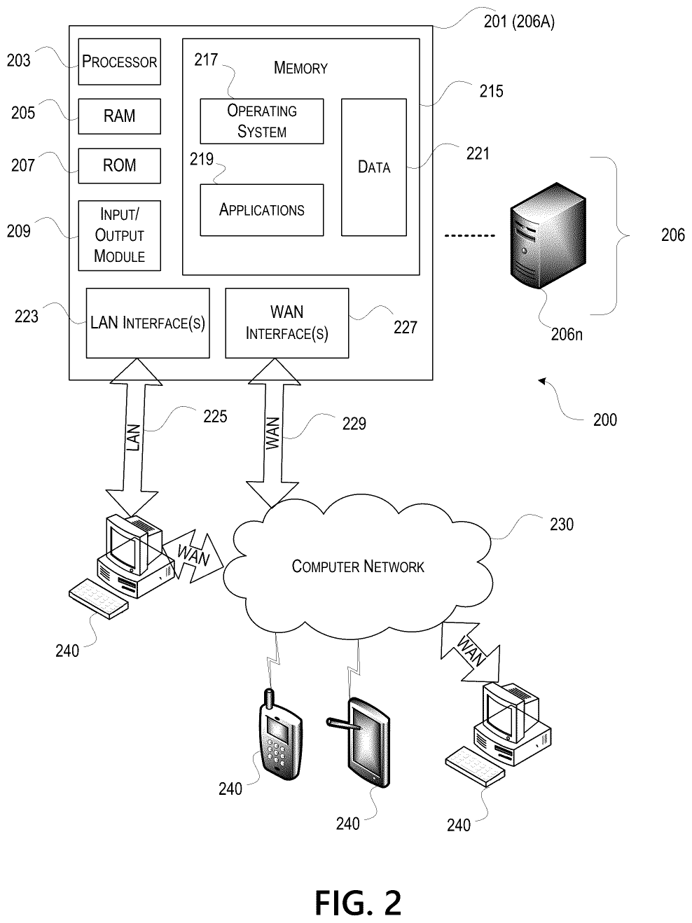

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Florida; or the Remote Desktop Protocol (RDP) manufactured by the Microsoft Corporation of Redmond, Washington.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, IOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

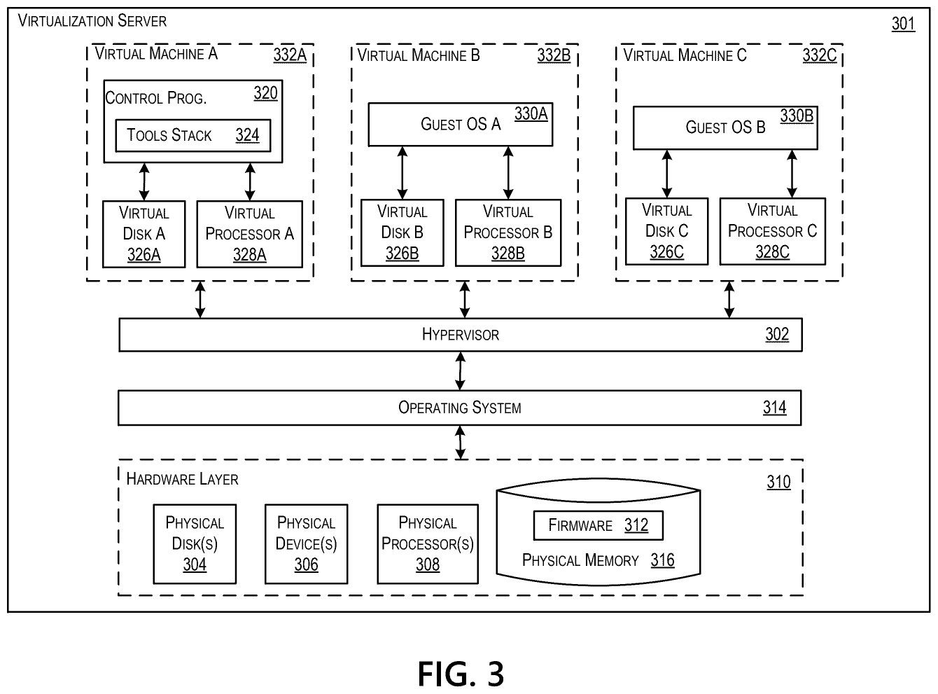

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMware, Inc., of Palo Alto, California; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, FL.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

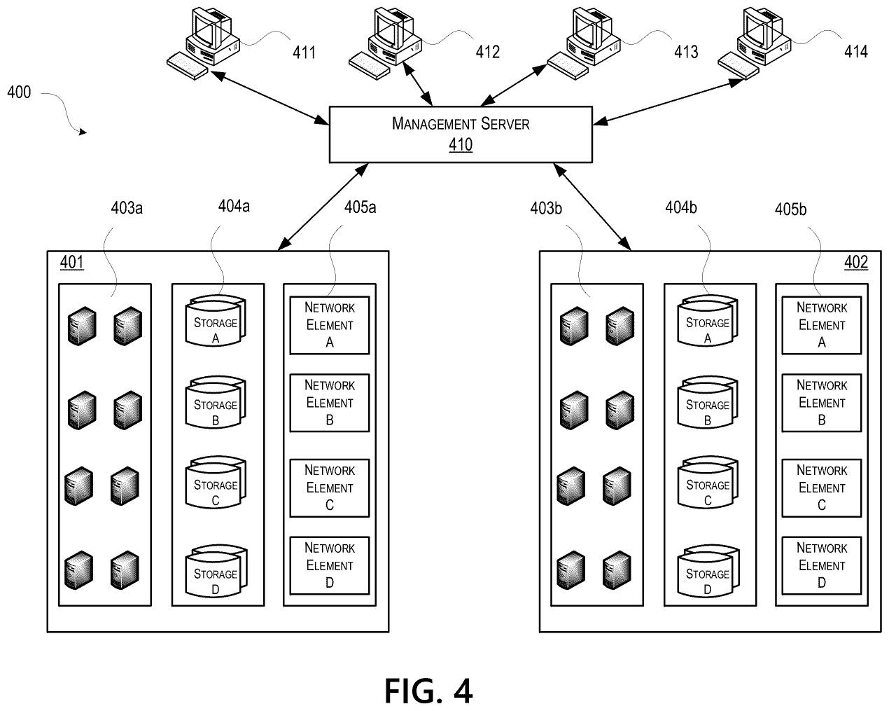

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, FL, or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on be of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond, Washington), AMAZON EC2 (Amazon.com Inc. of Seattle, Washington), IBM BLUE CLOUD (IBM Corporation of Armonk, New York), or others.

### Remote Computing Session Prelaunch

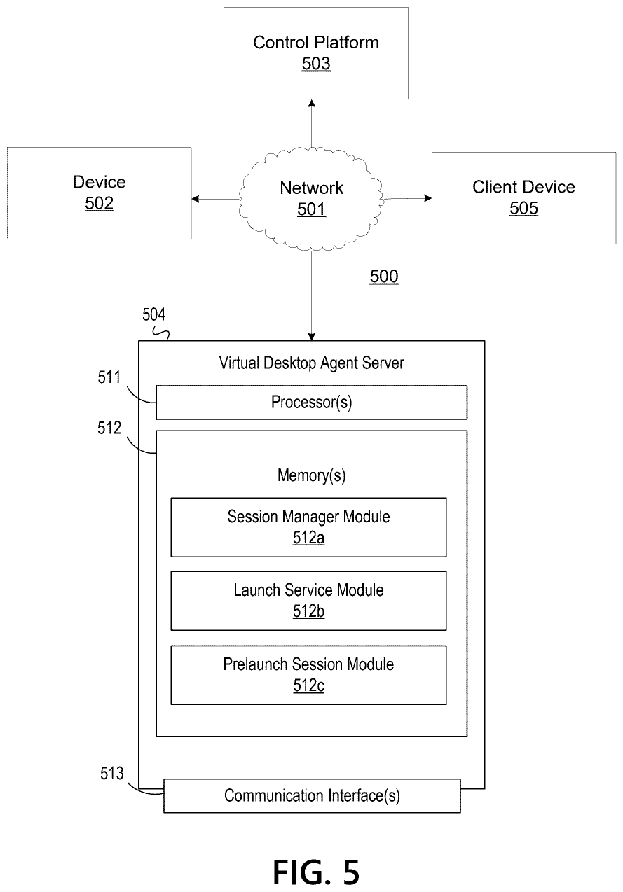

FIG. 5 depicts an illustrative computing environment for performing a remote computing session prelaunch in accordance with one or more example embodiments. Referring to FIG. 5, computing environment 500 may include one or more computer systems. For example, computing environment 500 may include a device 502, a control platform 503, a virtual desktop agent server 504, and a client device 505.

As illustrated in greater detail below, device 502 may, in some examples, be a personal computing device such as a smartphone, tablet, laptop computer, or the like. In some instances, device 502 may be configured to facilitate the use of virtual desktops, virtual applications, or the like, and thus may be configured to communicate with the virtual desktop agent server 504. Device 502 may be configured to host a virtual desktop client application facilitating a remote computing session prelaunch by performing authentication functions, communicating with one or more devices to prelaunch a remote computing session (e.g., control platform 503, virtual desktop agent server 504, client device 505), and/or performing other functions related to prelaunching a remote computing session.

Although portions of this disclosure describe device 502 as a mobile device, such as a smartphone, tablet, laptop computer, or the like, it should be understood that any device 502 may be and/or comprise any device configured to trigger a remote computing session prelaunch as described herein. For example, the device 502 may be and/or comprise a device or system of devices (e.g., a sensor and a transmitter) configured to identify that an employee has swiped a security card, badge, or the like and cause a virtual desktop agent server to initiate a prelaunch. In these examples, the device may perform a portion of the functions of the device 502 described herein (e.g., providing authentication information, sending and/or causing a prelaunch request to be sent to a control platform, and/or other functions) while omitting one or more other functions (e.g., receiving a prelaunch status). Although a single device 502 is depicted, any number of such devices may be implemented in the methods described herein without departing from the scope of the disclosure.

Control platform 503 may be a computer system that includes one or more computing devices (e.g., servers, server blades, smartphones, tablets, laptop computers, desktop computers, routers, or the like) and/or other computer components (e.g., processors, memories, communication interfaces). In some examples, the control platform 503 may comprise a plurality of different computing devices and/or services each configured to perform one or more functions to provide a remote computing session prelaunch as described herein. For example, the control platform 503 may comprise a cloud-based workspace, a storefront, a broker component such as a desktop delivery controller (DDC) configured to identify resource locations, negotiate licenses, and/or perform other functions related to hosting the one or more virtual desktops and/or other virtual applications, and/or other devices or services. In some examples, the control platform 503 may additionally or alternatively correspond to one or more computing devices and/or services. For example, the control platform 503 may be in communication with and/or otherwise have access to a broker component located, for example, at an on-premises datacenter. In these examples, the broker component may not be directly integrated into the control platform 503. In some examples, the control platform 503 may be configured to communicate with one or more of the device 502, the virtual desktop agent server 504, the client device 505, and/or other devices to provide a remote computing session prelaunch as described herein.

Virtual desktop agent server 504 may be a computer system that includes one or more computing devices (e.g., servers, server blades, or the like) and/or other computer components (e.g., processors, memories, communication interfaces). In one or more instances, virtual desktop agent server 504 may be configured to host one or more virtual desktop applications and/or other virtual applications, and may be configured to communicate with one or more devices (e.g., device 502, control platform 503, client device 505, or the like) to facilitate the use of such applications. In some examples, the virtual desktop agent server 504 may comprise one or more computer components (e.g., memories) storing modules, instructions, or the like configured to provide and/or interact with the device 502, control platform 503, and/or client device 505. In some examples, the virtual desktop agent server 504 may comprise a virtual desktop agent (e.g., the Citrix VDA developed by Citrix Systems, Inc. of Ft. Lauderdale, Florida). For example, the virtual desktop agent may have previously been installed on the virtual desktop agent server 504 to facilitate reception of information required for prelaunching a resource (e.g., from a virtual desktop client application as described herein). In these examples, the virtual desktop agent server 504 may additionally comprise a service that hosts/runs one or more instances of a lean virtual desktop client application to launch and/or prelaunch remote computing sessions without requiring any user interaction with a user interface (UI), as described further herein.

Client device 505 may be a personal computing device such as a laptop computer, desktop computer, or the like. In some instances, client device 505 may be configured to facilitate the use of virtual desktops, virtual applications, or the like, and thus may be configured to communicate with the virtual desktop agent server 504. In some examples, client device 505 may be associated with a user (e.g., the user associated with device 502). Although a single client device is depicted, any number of such devices may be implemented in the methods described herein without departing from the scope of the disclosure.

Computing environment 500 may also include one or more networks, which may interconnect device 502, control platform 503, virtual desktop agent server 504, and client device 505. For example, computing environment 500 may include a wired or wireless network 501 (which may e.g., interconnect device 502, control platform 503, virtual desktop agent server 504, and client device 505).

In one or more arrangements, device 502, control platform 503, virtual desktop agent server 504, client device 505, and/or the other systems included in the computing environment may be any type of computing device capable of receiving a user interface, receiving input via the user interface, and/or communicating the received input to one or more other computing devices. For example, device 502, control platform 503, virtual desktop agent server 504, client device 505, and/or the other systems included in the computing environment may in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of device 502, control platform 503, virtual desktop agent server 504, and client device 505 may, in some instances, be special purpose computing devices configured to perform specific functions.

Virtual desktop agent server 504 may include one or more processors 511, memory 512, and communication interface 513. A data bus may interconnect processor 511, memory 512, and communication interface 513. Communication interface 513 may be a network interface configured to support communication between the virtual desktop agent server 504 and one or more networks (e.g., network 501, or the like). Memory 512 may include one or more program modules having instructions that when executed by processor 511 cause virtual desktop agent server 504 to perform one or more functions described herein and/or access one or more databases that may store and/or otherwise maintain information which may be used by such program modules and/or processor 511. In some instances, the one or more program modules and/or databases may be stored by and/or maintained in different memory units of virtual desktop agent server 504 and/or by different computing devices that may form and/or otherwise make up virtual desktop agent server 504. For example, memory 512 may have, host, store, and/or include instructions that direct and/or otherwise cause virtual desktop agent server 504 to facilitate a remote computing session prelaunch. For example, the virtual desktop agent server 504 may store and/or otherwise include session manager module 512a, launch service module 512b, and/or prelaunch session module 512c.

Session manager module 512a may be configured to facilitate establishment of a remote computing session between a client device (e.g., client device 505) and the virtual desktop agent server 504, authenticate a prelaunch request from a mobile device (e.g., device 502), and/or facilitate other functions described herein. In some examples, session manager module 512a may comprise a broker proxy component configured to facilitate communication with a delivery controller (DDC) to link, authenticate, and/or otherwise establish a connection between a mobile device (e.g., device 502) and the virtual desktop agent server 504. For example, session manager module 512a may comprise instructions and/or directions for the virtual desktop agent server 504 to communicate with a DDC included in, and/or corresponding to, the control platform 503. Launch service module 512b may be configured to facilitate prelaunch of a remote computing session. In some examples, launch service module 512b may be and/or comprise a prelaunch orchestrator service application configured to hard-code client device details, generate a local user context, and/or otherwise facilitate initiation of a utility remote computing session (e.g., a session which allows one or more instances of a virtual desktop client application to run on a VDA server, with a UI, for one or more different users) for use in prelaunching a remote computing session. Also or alternatively, in some examples, launch service module 512b may be and/or comprise a service which hosts/runs one or more instances of a lean virtual desktop client application configured to facilitate a remote computing session prelaunch without requiring any user interaction with a UI. The lean virtual desktop client application may be used for a session prelaunch without processing display information or causing output of a display (e.g., a UI). The service running the lean virtual desktop client application may be a dedicated service corresponding to an operating system. The service may execute the lean virtual desktop client application in the context of the operating system to perform a loopback connection (e.g., connecting from and to the virtual desktop agent server 504) with a remote computing session protocol (e.g., ICA) to initiate a prelaunch session as described herein. Prelaunch session module 512c may be configured to facilitate initiating a prelaunch session based on a prelaunch session file, connect a prelaunch session to a client device (e.g., client device 505), and/or perform other functions related to prelaunch a remote computing session described herein.

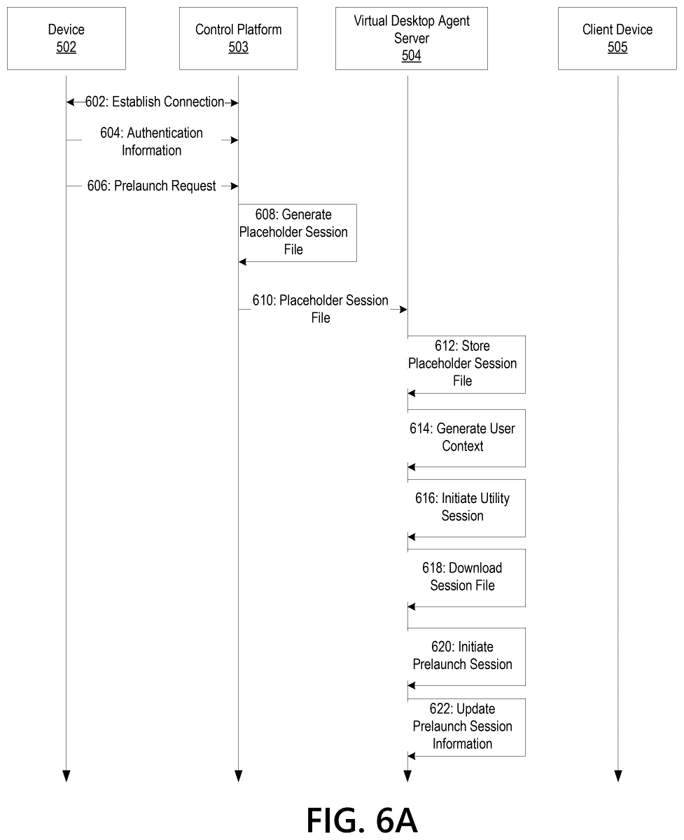

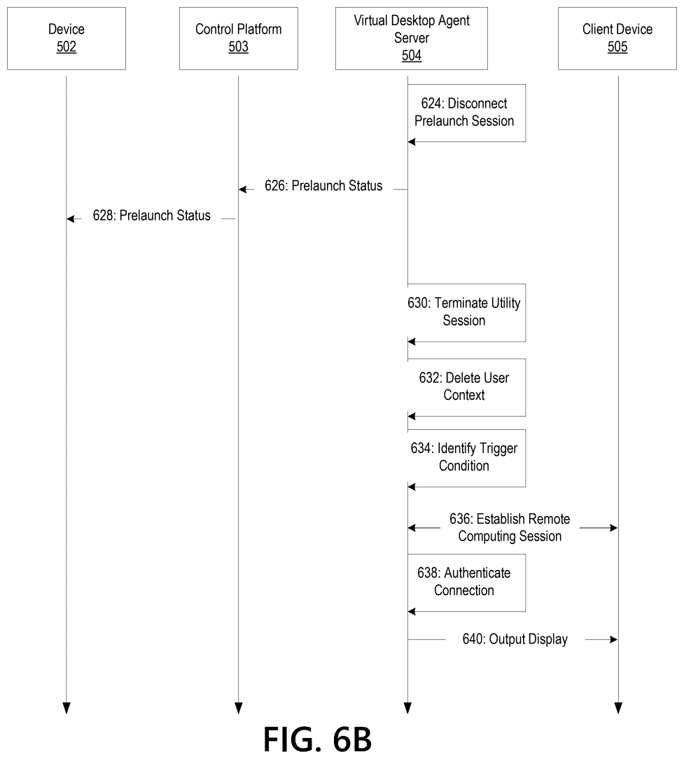

FIGS. 6A-6B depict an illustrative event sequence for performing a remote computing session prelaunch in accordance with one or more example embodiments. It should be understood that steps 602-640 may, in some instances, occur in the order as shown with regard to FIGS. 6A-6B. For example, after completing step 622 of FIG. 6A, the event sequence may proceed to step 624 of FIG. 6B.

Referring to FIG. 6A, at step 602, the device 502 may communicate with the control platform 503 to establish an initial connection between the device 502 and the control platform 503. For example, the device 502 may establish a connection with the control platform 503 to request a remote session prelaunch be executed by a device (e.g., virtual desktop agent server 504) that facilitates a remote and/or other virtual computing session prelaunch. In some examples, the device 502 may communicate with the control platform 503 through a virtual desktop client application. In these examples, the virtual desktop client application may be an application configured for prelaunching a remote computing session, performing authentication, and communicating with the control platform 503, but which does not require the launch of the virtual desktop client application in the foreground of the device 502. By limiting the functionality of the virtual desktop client application to authentication and communicating with the control platform 503 the methods described herein may improve the user experience (e.g., by reducing battery usage and/or by providing a remote computing session prelaunch without interrupting the ability of the user to freely use the device 502 for the duration of the prelaunch).

At step 604, the control platform 503 may receive authentication information from the device 502. For example, the control platform 503 may receive the authentication information via the virtual desktop client application. The authentication information may comprise user identification information (e.g., usernames, account names, or the like), passwords, encryption keys, biometric information, and/or other authentication information. In some examples, based on receiving the authentication information, the control platform 503 may automatically authenticate the device 502 (e.g., by authenticating the user of the device 502 based on the authentication information). For example, the control platform 503 may communicate with a broker component (e.g., a DDC, included in and/or corresponding to the control platform 503) to authenticate the device 502 and/or a license corresponding to the device 502.

At step 606, the control platform 503 may receive a prelaunch request from the device 502. For example, the control platform 503 may receive a request to prelaunch a remote computing session using a virtual desktop agent (VDA) hosted and/or otherwise maintained by the virtual desktop agent server 504. In some examples, the prelaunch request may comprise information pertaining to launching a remote computing session. For example, the prelaunch request may comprise information used to generate a session file (e.g., an ICA file, and/or other session files corresponding to different protocols) for a remote computing session without UI (e.g., as part of providing a service hosting one or more instances of a lean virtual desktop application as described herein). In some examples, the prelaunch request may be received based on manual user input. For example, device 502 may be and/or comprise a mobile device, such as a mobile phone, from which a user manually triggers the request. In some examples, the prelaunch request may be sent to the control platform 503 automatically. For example, device 502 may be and/or comprise a sensor and communication interface that automatically sends the prelaunch request based on detecting, with the sensor, a security badge of a user entering a threshold proximity of the sensor.

At step 608, the control platform 503 may generate a placeholder session file. For example, the control platform 503 may generate a session file comprising parameters for establishing a remote computing session (e.g., identification of one or more resources corresponding to the remote computing session, identification of a launch protocol corresponding to the remote computing session, and/or other parameters). In some examples, in and/or based on generating the placeholder session file, the control platform 503 may store the placeholder session file (e.g., to memory 512, and/or to other storage). In some examples, in generating the placeholder session file, the control platform 503 may utilize and/or communicate with the brokering component (e.g., a DDC, included in the control platform 503 or located at an on-premises datacenter corresponding to a client of the entity associated with the control platform 503). For example, the control platform 503 may request, instruct, and/or otherwise communicate with the brokering component to generate a placeholder session file (e.g., a “dummy” session file corresponding to a protocol such as ICA). In some examples, the placeholder session file may correspond to a dummy-ICA protocol. The dummy-ICA protocol may replicate one or more features of the ICA protocol without the need for a connection between the virtual desktop agent server 504 and any other devices. The placeholder session file may additionally or alternatively comprise authentication information and/or other information required to authenticate a remote computing session with one or more authentication services (e.g., a federated authentication service as described in U.S. Pat. No. 10,122,703, issued Nov. 6, 2018 and entitled “Federated Full Domain Logon” which is hereby incorporated by reference in its entirety for all purposes).

At step 610, the may send the placeholder session file to the virtual desktop agent server 504. The virtual desktop agent server 504 may receive the placeholder session file (e.g., via the communication interface 513).

At step 612, based on receiving the placeholder session file, the virtual desktop agent server 504 may store the placeholder session file. For example, the virtual desktop agent server 504 may store the placeholder session file to memory (e.g., memory 512, or the like). The virtual desktop agent server 504 may, based on receiving and storing the placeholder session file, proceed to prelaunch a remote computing session.

In some examples, the virtual desktop agent server 504 may perform, or not perform, one or more of the functions of prelaunching a remote computing session as described herein based on a launch service application the virtual desktop agent server 504 is configured to utilize. For example, the virtual desktop agent server 504 may comprise a launch service application (e.g., a prelaunch orchestrator service application, a lean virtual desktop application, and/or other service applications) configured to utilize some or all of the information included in the placeholder session file to prelaunch a remote computing session with or without UI. For example, the virtual desktop agent server 504 may comprise a prelaunch orchestrator service configured to use the placeholder session file to generate a utility remote computing session (e.g., using a pseudo remote computing protocol, as described further herein) to prelaunch a remote computing session with UI. In these examples, the virtual desktop agent server 504 may proceed to step 614. Also or alternatively, in some examples, the virtual desktop agent server 504 may comprise a service that hosts/runs one or more instances of a lean virtual desktop application. The lean virtual desktop application may facilitate prelaunch of a remote computing session which does not require any user interaction with a UI. In these examples, the virtual desktop agent server 504 may not need to authenticate to a user and/or utilize a utility session. For example, the placeholder session file may comprise all information (e.g., user information, resource location information, licensing information, or the like) required to prelaunch a remote computing session without UI. In these examples, the virtual desktop agent server 504 may proceed to step 620 without performing the functions recited at steps 614-618.

At step 614, the virtual desktop agent server 504 may generate one or more user contexts. For example, the virtual desktop agent server 504 may, based on stored user information, a local user context for the placeholder session file. In some examples, the local user context may comprise spoofed client device information and/or spoofed user information. For example, the local user context may comprise hard coded client device information such as computer specifications (e.g., graphics card information, RAM, or the like), a number of available monitors for hosting a remote computing session, a location of one or more monitors for hosting a remote computing session, and/or other client device information that represents a user. The local user context may correspond to a local user (i.e., local to the virtual desktop agent server 504) that is created by a service with privileges and/or permissions to represent a real domain/active directory user (e.g., a user of a client device such as client device 505). In some examples, the local user context may correspond to a random and/or fictional user serving as a placeholder for the user associated with the device 502 and/or the user associated with the client device 505. For example, the virtual desktop agent server 504 may generate the local user context “on the fly” based on randomized user information comprising information stored at the virtual desktop agent server 504 during one or more previous remote computing sessions with other client devices and/or received by the virtual desktop agent server 504 as user input from a user (e.g., an administrator of the institution corresponding to the virtual desktop agent server 504). In some examples, the local user context may correspond to the user associated with the device 502 and/or the user associated with the client device 505. For example, the virtual desktop agent server 504 may generate a local user context based on user information stored at the virtual desktop agent server 504 and received from the device 502 and/or the client device 505 during previous remote computing session.

It should be understood that, in some examples, the local user context is created as needed to initiate a utility session (as described at step 616). The local user context has no relationship to the user (e.g., user of device 502 and/or of client device 505) requesting a remote computing session and/or a remote computing session prelaunch. In some examples, the user context may be generated prior to receiving the prelaunch request as described herein. In these examples, the user context may be generated based on randomized user information as described above after the virtual desktop agent server 504 reboots. In these examples, the utility remote computing session may be initiated as described at step 616 after the virtual desktop agent server 504 as well. It should also be understood that multiple user contexts may be generated. For example, a different user context may be generated for each of a plurality of domain users corresponding to prelaunch requests.

At step 616, the virtual desktop agent server 504 may initiate a utility remote computing session. For example, the virtual desktop agent server 504 may initiate the utility remote computing session based on the one or more user contexts generated at step 614. In initiating the utility remote computing session, the virtual desktop agent server 504 may cause a launch service application, for example, a prelaunch orchestrator service comprising a utility remote computing session manager (e.g., a dummy session manager).

The launch service application may initiate a utility remote computing session that allows one or more instances of the virtual desktop client application to run on the virtual desktop agent server 504. The launch service application may utilize a pseudo remote computing protocol (e.g., a pseudo-ICA protocol) that is and/or comprises a simplified version of a protocol (e.g., ICA) which, for example, may not connect to a remote display, and/or may be otherwise simplified. The pseudo remote computing protocol may be installed on the virtual desktop agent server 504 (e.g., as a remote protocol handler and/or subsystem built into a dynamic link library, and/or otherwise installed on the virtual desktop agent server 504). The pseudo remote computing protocol may be used to establish a loopback connection connecting the virtual desktop agent server 504 to the utility remote computing session (in effect connecting the virtual desktop agent server 504 to itself). Establishing the loopback connection may trigger the creation of the utility remote computing session that hosts and/or otherwise maintains a representation of a remote computing session, without the use of a client device, using internal components of the virtual desktop agent server 504.

The utility remote computing session may require authentication to a user. The virtual desktop agent server 504 may provide the authentication based on the user context. For example, the virtual desktop agent server 504 may cause the launch service application to initiate a utility remote computing session without any physical client device attached using the information stored in the local user context. For example, the local user context may comprise information replicating and/or otherwise representing device information for one or more real physical devices. In these examples, the virtual desktop agent server 504 may use the device information to initiate a utility remote computing session internal to the virtual desktop agent server 504 (e.g., between the launch service application and a virtual device) representing a remote computing session between a physical client device and the virtual desktop agent server 504. For example, based on device information representing a monitor and a laptop computer, the virtual desktop agent server 504 may initiate a utility remote computing session replicating a remote computing session between the virtual desktop agent server 504 and a virtual laptop computer connected to a virtual monitor. It should be understood that by using the local user context to initiate the utility remote computing session, the virtual desktop agent server 504 may initiate a utility remote computing session that includes UI information. In these examples, a UI might not be displayed because the utility remote computing session is not connected to a physical display device. In initiating the utility remote computing session, the virtual desktop agent server 504 may launch one or more resources (e.g., applications, programs, or the like), configure the session based on a user context, and/or perform other functions to facilitate a remote computing session, without establishing a connection to any physical device.

In some examples, a utility session as described herein may be used to allow one or more additional instances of the virtual desktop client application to run on the virtual desktop agent server 504. For example, a user context as described herein may be used to run concurrent virtual desktop client applications (in the utility session, as separate processes). In some examples, multiple user contexts may be used (e.g., one user context for each domain user requesting a prelaunch). In these examples, the utility session may run a different instance of a virtual desktop client application to initiate a different prelaunch session for each of a plurality of different domain users. In these examples, after first initiating a utility session as described herein, the initiated utility session may be re-used to initiate each prelaunch session (as described at step 618) for each user.

At step 618, the virtual desktop agent server 504 may download a session file. For example, the virtual desktop agent server 504 may download a session file corresponding to the user of the device 502 and/or the user of the client device 505. In some examples, in downloading the session file, the virtual desktop agent server 504 may identify the session file based on user information corresponding to the device 502. For example, the virtual desktop agent server 504 may use one or more identifiers (e.g., account names, license information, or the like) of the user of the device 502 to identify which session file to download. In downloading the session file, the virtual desktop agent server 504 may download a protocol-specific session file, for example, an ICA file, corresponding to the user of the device (e.g., the device 502) requesting the remote computing session prelaunch. The virtual desktop agent server 504 may download the session file via the launch service application and from a database, disk, or the like, maintaining user-specific and/or device-specific session files. The session file may comprise user information corresponding to the device 502. For example, the session file may comprise a user context associated with a user of the device 502, device information corresponding to additional devices (e.g., the client device 505) associated with a user of the device 502, authentication information (e.g., a password, username, token, and/or the like) associated with a user of the device 502, and/or other user information related to configuration settings for establishing remote computing sessions.

At step 620, based on downloading the session file and/or based on utilizing a service that hosts/runs one or more instances of a lean virtual desktop application, the virtual desktop agent server 504 may initiate a prelaunch session. For example, the virtual desktop agent server 504 may initiate a prelaunch session based on the placeholder session file and using the launch service application. In some examples, the virtual desktop agent server 504 may initiate the prelaunch session based directly on the placeholder session file. For example, the launch service application may be and/or comprise service that hosts/runs one or more instances of a lean virtual desktop application configured to prelaunch a remote computing session without any UI information. In these examples, the lean virtual desktop application may initiate a prelaunch session based on configuration information included in the prelaunch request and without any UI information.

In some examples, the virtual desktop agent server 504 may initiate the prelaunch session based on updating and/or replacing the placeholder session file with the session file downloaded at step 618. For example, the virtual desktop agent server 504 may update the placeholder session file generated at step 608 as described herein. In some examples, the virtual desktop agent server 504 may update the placeholder session file based on information included in the session file. For example, the virtual desktop agent server 504 may update the placeholder session file based on user information (e.g., configuration information for remote computing sessions corresponding to the device 502 and/or the user of the device 502, configuration information for remote computing sessions corresponding to the client device 505 and/or the user of the client device 505, one or more user profiles corresponding to the client device 505 and/or the device 502, and/or other user information included in the session file). In updating the placeholder session file, the virtual desktop agent server 504 may add information to the placeholder session file, modify information of the placeholder session file, and/or remove information from the placeholder session file based on the session file. In these examples, the launch service application may be and/or comprise a prelaunch orchestrator service configured to prelaunch the remote computing session based on a pseudo-ICA protocol. In these examples, the virtual desktop agent server 504 may initiate the prelaunch session by performing a loopback connection with a standard remote computing protocol (e.g., ICA). The loopback connection may be performed using the utility session running an instance of the virtual desktop client application. In these examples, any display corresponding to the prelaunch session may be remoted in the utility session. As described elsewhere herein, in these examples the utility session may not be attached to any monitor or other display device, and thus no actual display may occur. In these examples, the virtual desktop agent server 504 may initiate the prelaunch session (i.e., using the utility session) based on configuration information included in the updated placeholder session file and/or in the session file downloaded at step 618. For example, the virtual desktop agent server 504 may initiate the prelaunch session, based at least in part on the utility remote computing session, by modifying one or more parameters of the utility remote computing session based on the updated placeholder session file.

In initiating the prelaunch session, the virtual desktop agent server 504 may initiate the prelaunch session using a client engine (e.g., an ICA client engine) replicating one or more functions of a physical device. The client engine may be installed on the virtual desktop agent server 504. In some examples, in initiating the prelaunch session, the virtual desktop agent server 504 may store prelaunch session information. For example, the virtual desktop agent server 504 may store a status indicator indicating that the prelaunch session has been initiated, one or more parameters of the prelaunch session (e.g., indicators of a protocol, such as ICA, corresponding to the prelaunch session, device information corresponding to the prelaunch session, an indicator of the device (e.g., device 502) requesting the remote computing session, an indicator of a target device (e.g., client device 505) for establishing the remote computing session, and/or other parameters of the prelaunch session) and/or other information. The virtual desktop agent server 504 may store the prelaunch session information to temporary storage, such as RAM, a temporary storage buffer, or the like, and/or to memory 512.

At step 622, the virtual desktop agent server 504 may update prelaunch session information. For example, the virtual desktop agent server 504 may load one or more profiles. The profiles may correspond to the user of the device 502. The profiles may be identified and/or loaded based on the information included in the placeholder session file and/or the downloaded session file. For example, based on the placeholder session file, the virtual desktop agent server 504 may identify a storage location, filepath, or the like indicating a user profile corresponding to the user of the device 502 and/or the client device 505. In these examples, the virtual desktop agent server 504 may load the one or more profiles to configure the prelaunch session to incorporate user preferences and/or parameters for remote computing sessions (e.g., system settings, UI settings, startup procedures, application settings, or the like). The user profiles may represent a one-to-one connection between a real user and the prelaunch session. For example, the user profile may comprise user preferences and settings corresponding to an operating system, display, and/or other elements of a computing session. In some examples, the user profile may be a roaming profile that is downloaded from a server or the like. In some examples, the profile may be created locally on the virtual desktop agent server 504. Also or alternatively, in some examples, based on and/or while loading the one or more profiles the virtual desktop agent server 504 may launch one or more applications. For example, the virtual desktop agent server 504 may, as part of the prelaunch session, launch one or more applications identified (e.g., by user preferences) as applications to launch on startup of a remote computing session. Additionally or alternatively, the virtual desktop agent server 504 may launch one or more applications required to prelaunch the remote computing session. For example, the request received at step 606 may have identified one or more applications to launch as part of the remote computing session prelaunch. The virtual desktop agent server 504 may prelaunch these one or more applications during initiation of the prelaunch session.

Referring to FIG. 6B, at step 624, based on loading the one or more profiles, the virtual desktop agent server 504 may, based on storing the prelaunch session information, disconnect the prelaunch session. For example, the virtual desktop agent server 504 may pause, interrupt, and/or otherwise disconnect the loopback connection corresponding to the prelaunch session. In disconnecting the prelaunch session, may maintain the prelaunch session in an idle, or offline, state without maintaining an active connection between components of the virtual desktop agent server 504. In these examples, the disconnected prelaunch session may be configured to be reconnected based on one or more commands from the virtual desktop agent server 504.

At step 626, based on disconnecting the prelaunch session, the virtual desktop agent server 504 may send a prelaunch status indicator to the control platform 503 (e.g., via the communication interface 513). In some examples, the virtual desktop agent server 504 may set the prelaunch status indicator to the control platform 503 via a brokering component (e.g., a DDC, included in the control platform 503 or stored at an on-premises data center). The prelaunch status indicator may comprise information indicating that the remote computing session prelaunch has been completed, information indicating that all profiles required to launch a remote computing session have been loaded, and/or other information.

At step 628, the control platform 503 may send a prelaunch status indicator to the device 502. The prelaunch status indicator may be or comprise the prelaunch status indicator received by the control platform 503 at step 626. The prelaunch status indicator may indicate, to a user of the device 502, that the remote computing session prelaunch has been completed and that a remote computing session between a client device of the user (e.g., client device 505) and the virtual desktop agent server 504 may be established once a trigger condition is satisfied.

At step 630, based on sending the prelaunch status indicator to the control platform 503, the virtual desktop agent server 504 may terminate a utility remote computing session. For example, the virtual desktop agent server 504 may delete, sever, disconnect, and/or otherwise terminate the utility remote computing session previously initiated using a prelaunch orchestrator service (e.g., as described at step 616). In some examples, as previously described, the virtual desktop agent server 504 may have initiated the prelaunch session using a lean virtual desktop application to prelaunch a remote computing session, based directly on the information included in the session file received from a broker (e.g., a DDC), without UI. It should be understood that in these examples the functions recited at step 630 may not be performed and the virtual desktop agent server 504 may proceed to delete the one or more user contexts at step 632 after disconnecting the prelaunch session at step 628.

As described herein, in some examples, the utility session may be used to perform prelaunch a remote computing session for one or more additional users. For example, the utility session may be used to prelaunch a different remote computing session for each of a plurality of different users, each session being brokered to the same virtual desktop agent server 504. Also or alternatively, the utility session may be used to perform a subsequent or repeat prelaunch for a specific user. For example, based on performing the functions described herein with respect to FIGS. 6A-6B a remote computing session may be prelaunched for a user who subsequently logs off. In these examples, the utility session may be re-used for a subsequent prelaunch request from the same user. It should therefore be understood that in some examples the utility session may not be terminated as described above and the virtual desktop agent server 504 may proceed to step 632 directly after disconnecting the prelaunch session at step 628.

At step 632, the virtual desktop agent server 504 may delete the local user context. For example, the virtual desktop agent server 504 may remove the local user context, previously generated at step 614, from memory (e.g., memory 512) of the virtual desktop agent server 504. In deleting the local user context, the methods of performing a remote computing session prelaunch described herein may provide benefits of reducing an amount of computing resources (e.g., memory, or the like) required to perform a remote computing session prelaunch. For example, by generating the local user context and deleting the local user context after initiating the prelaunch session as described herein, the virtual desktop agent server 504 may eliminate the need to maintain an active user context for each real user (e.g., each client of a provider of remote computing services).

At step 634, the virtual desktop agent server 504 may identify whether one or more trigger conditions for establishing the remote computing session between the virtual desktop agent server 504 and the client device 505 have been satisfied. For example the virtual desktop agent server 504 may identify whether one or more trigger conditions for establishing the remote computing session have been satisfied based on actions performed by the user of the client device 505, by the client device 505, and/or by the device 502. In some examples, the one or more trigger conditions may comprise passage of a predetermined (e.g., by user preferences, by system settings of the virtual desktop agent server 504, and/or by other means) amount of time after initiating the prelaunch session, the presence of the device 502 within a threshold proximity of the client device 505, confirmation of authentication of the client device 505, and/or other trigger conditions. For example, a trigger condition may be satisfied based on authenticating, prior to establishing the remote computing session, the client device 505 (e.g., by authenticating a user of the client device 505). In these examples, a security policy, user setting, or the like corresponding to the virtual desktop agent server 504 may require authentication of any client devices and/or users of client devices prior to establishing a remote computing session based on a prelaunched remote computing session. The virtual desktop agent server 504 may identify that the trigger condition is satisfied based on authenticating, via authentication information (e.g., a password, encryption key, user profile, license agreement, device identifier (e.g., an IP address, a MAC address, or the like) and/or other authentication information), the client device 505 as a device authorized to establish a remote computing session with the virtual desktop agent server 504.

Also or alternatively, a trigger condition may be satisfied based on, for example, determining that a predetermined amount of time has passed after initiating the prelaunch session. For example, the virtual desktop agent server 504 may be configured to automatically establish a remote computing session between the virtual desktop agent server 504 and the client device (e.g., the client device 505) identified by the prelaunch request based on determining that a predetermined amount of time (e.g., seconds, minutes, hours, and/or other periods of time) has been met or exceeded after performing the functions described at step 620. Also or alternatively, a trigger condition may be satisfied based on, for example, identifying that a user of the device 502 and/or the device 502 is located within a threshold proximity of the client device 505. For example, the virtual desktop agent server 504 may be configured to automatically establish a remote computing session between the virtual desktop agent server 504 and the client device 505, based on the prelaunch session, and based on determining that the device 502 has entered a geometric and/or geographic region surrounding a physical location of the client device 505. For example, the virtual desktop agent server 504 may determine, based on a global positioning system (GPS) application and/or other positioning applications, whether the device 502 has entered with a threshold distance (e.g., feet, meters, inches, and/or other distances) of the physical location of the client device 505 and/or whether the device 502 has entered a space (e.g., a room, building, or the like) corresponding to the physical location of the client device 505. It should be understood that the trigger conditions described herein are merely examples and that additional or alternative trigger conditions may be utilized in systems implementing the methods of performing a remote computing session prelaunch described herein.

At step 636, based on identifying that one or more trigger conditions have been satisfied, the virtual desktop agent server 504 may establish a remote computing session. For example, the virtual desktop agent server 504 may establish a remote computing session between the virtual desktop agent server 504 and the client device 505. In establishing the remote computing session, the virtual desktop agent server 504 may reconnect the prelaunch session that was disconnected (e.g., as described at step 624). For example, the virtual desktop agent server 504 may reconnect a loopback connection (e.g., to a lean virtual desktop application and/or to a utility session). Based on reconnecting the prelaunch session, the virtual desktop agent server 504 may establish the remote computing session by modifying the terminals of the prelaunch session to include the client device 505. For example, the virtual desktop agent server 504 may modify the prelaunch session such that a first terminal of the connection corresponds to the client device 505 and a second terminal of the connection corresponds to one or more internal components of the virtual desktop agent server 504. By establishing the remote computing session based on reconnecting the prelaunch session the method of performing a remote computing session prelaunch as described herein may eliminate the need for a new remote computing session to be launched by the virtual desktop agent server 504. Accordingly, the methods described herein may bypass processes required to launch a new remote computing session (e.g., profile loading, application launching, and/or other time-consuming operations) that were previously performed during the remote computing session prelaunch. Thus, the methods of performing a remote computing session prelaunch as described herein provide improvements to speed and efficiency over conventional systems of launching a remote computing session.

At step 638, the virtual desktop agent server 504 may authenticate the remote computing session. For example, in some arrangements, authentication of the connection between the virtual desktop agent server 504 and the client device 505 may be required prior to outputting a display as part of the remote computing session, launching one or more resources, and/or otherwise granting the user of the client device 505 full access to the remote computing session. In authenticating the remote computing session, the virtual desktop agent server 504 may authenticate the remote computing session via authentication information (e.g., a password, encryption key, user profile, license agreement, device identifier (e.g., an IP address, a MAC address, or the like) and/or other authentication information), the client device 505 as a device authorized to establish a remote computing session with the virtual desktop agent server 504.

In some examples, the virtual desktop agent server 504 may have previously authenticated the connection between the virtual desktop agent server 504 and the client device 505, as described herein. Also or alternatively, in some examples, one or more policies, configurations, settings, or the like may indicate that authentication is not necessary after establishing the remote computing session. In these examples, the virtual desktop agent server 504 may proceed to step 640 without performing the functions recited herein at step 638.

At step 640, the virtual desktop agent server 504 may output a display. For example, the virtual desktop agent server 504 may send, transmit, and/or otherwise provide one or more commands, via the remote computing session, directing the client device 505 to display a user interface comprising one or more graphical elements corresponding to the remote computing session. For example, the virtual desktop agent server 504 may cause the client device 505 to display a virtual desktop corresponding to a virtual desktop agent hosted by the virtual desktop agent server 504.

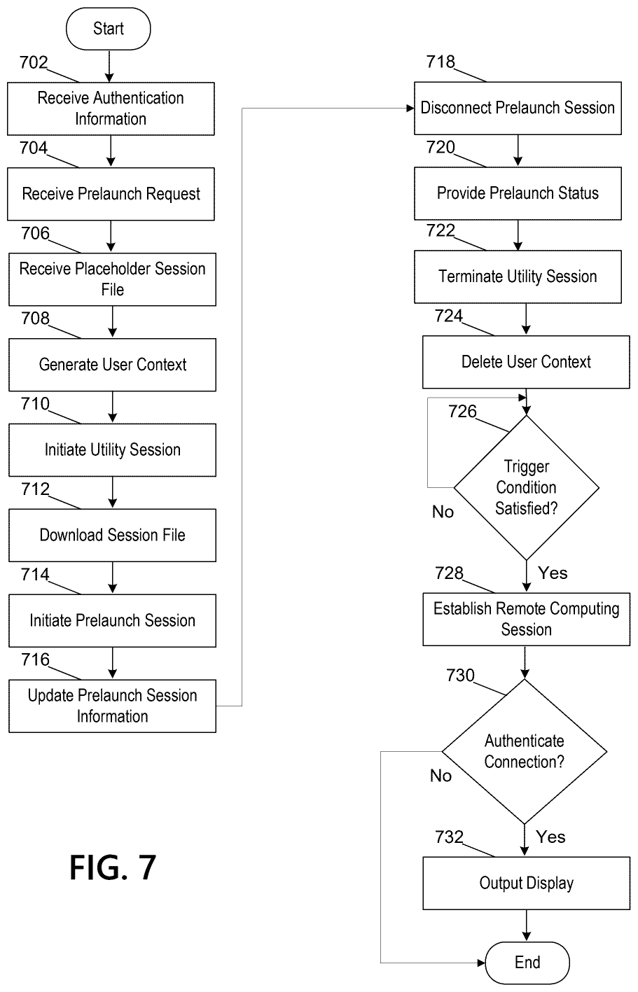

FIG. 7 depicts an illustrative method for performing a remote computing session prelaunch using a prelaunch orchestrator service in accordance with one or more illustrative aspects described herein. Referring to FIG. 7, at step 702, a computing system comprising a memory and one or more processors may receive authentication information. For example, the computing system may receive authentication information for a mobile device hosting a virtual desktop client application. At step 704, the computing system may receive a prelaunch request. For example, the computing system may receive a request to prelaunch a remote computing session. At step 706, the computing system may receive a placeholder session file. For example, the computing system may receive a placeholder session file from a control platform. In some examples, the prelaunch request of step 704 and the authentication information of step 702 may be received by the computing system with and/or as part of the placeholder session file received from the control platform. At step 708, the computing system may generate a user context. For example, the computing system may generate a local user context for use in replicating a remote computing session. At step 710, the computing system may initiate a utility session. For example, the computing system may initiate a dummy or placeholder remote computing session using a prelaunch orchestrator service and internal components of the computing system. At step 712, the computing system may download a session file corresponding to the remote computing session. For example, the computing system may download and ICA file and/or other session files based on the utility session.

At step 714, the computing system may initiate a prelaunch session. For example, the computing system may initiate a representation of a remote computing session between the computing system and a client device using internal components of the computing system. At step 716, the computing system may update prelaunch session information. For example, the computing system may load one or more profiles corresponding to the prelaunch session and update the prelaunch session information to indicate the profiles have been uploaded. At step 718, the computing system may disconnect the prelaunch session. For example, the computing system may disconnect the prelaunch session without deleting the prelaunch session. At step 720, the computing system may provide a prelaunch status indicator to the device that provided the prelaunch request. At step 722, the computing system may terminate the utility session. At step 724, the computing system may delete the user context previously generated by the computing system. At step 726, the computing system may determine whether a trigger condition has been satisfied. For example, the computing system may determine whether a trigger condition for launching a remote computing session has been satisfied. Based on identifying that no trigger condition has been satisfied, the computing system may return to step 726 and continue determining whether a trigger condition has been satisfied. Based on identifying that a trigger condition has been satisfied, the computing system may proceed to step 728. At step 728, the computing system may establish a remote computing session. For example, the computing system may reconnect the prelaunch session to establish a remote computing session between the computing system and a client device. At step 730, the computing system may identify whether the remote computing session is authenticated. In some examples, the computing system may authenticate the remote computing session at step 730. In some examples, the computing system may identify whether the remote computing session was previously authenticated. Based on identifying that the remote computing session is not authenticated or based on identifying that authentication is not required, the computing system may end the method depicted in FIG. 7. Based on identifying that the remote computing session is authenticated, the computing system may proceed to step 732. At step 732, the computing system may output a display. For example, the computing system may output a virtual desktop to the client device.

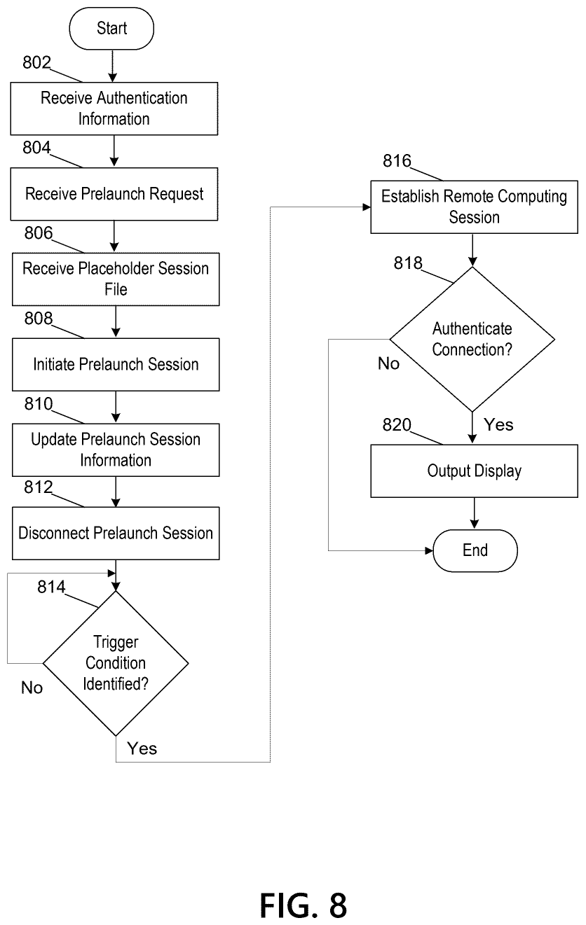

FIG. 8 depicts an illustrative diagram for performing a remote computing session prelaunch using a lean virtual desktop application in accordance with one or more illustrative aspects described herein. Referring to FIG. 8, at step 802, a computing system comprising a memory and one or more processors may receive authentication information. For example, the computing system may receive authentication information for a computing device to connect to a server hosting a virtual desktop client application. At step 804, the computing system may receive a prelaunch request. For example, the computing system may receive a request to prelaunch a remote computing session. In some examples, the prelaunch request may comprise information required to launch the remote computing session (e.g., device information, or the like). At step 806, the computing system may receive a placeholder session file. For example, the computing system may receive a placeholder session file comprising any and all information required to prelaunch a remote computing session using a service hosting one or more instances of a lean virtual desktop application as described herein. In some examples, the computing system may receive the placeholder session file from a control platform. In some examples, the prelaunch request of step 804 and the authentication information of step 802 may be received by the computing system with and/or as part of the placeholder session file received from the control platform. At step 808, the computing system may initiate a prelaunch session. For example, the computing system may initiate a representation of a remote computing session between the computing system and a client device using internal components of the computing system. At step 810, the computing system may update prelaunch session information. For example, the computing system may load one or more profiles corresponding to the prelaunch session and update the prelaunch session information to indicate the profiles have been uploaded. At step 812, the computing system may disconnect the prelaunch session. For example, the computing system may disconnect the prelaunch session without deleting the prelaunch session.

At step 814, the computing system may determine whether a trigger condition has been satisfied. For example, the computing system may determine whether a trigger condition for launching a remote computing session has been satisfied. Based on identifying that no trigger condition has been satisfied, the computing system may return to step 814 and continue determining whether a trigger condition has been satisfied. Based on identifying that a trigger condition has been satisfied, the computing system may proceed to step 816. At step 816, the computing system may establish a remote computing session. For example, the computing system may reconnect the prelaunch session to establish a remote computing session between the computing system and a client device. At step 818, the computing system may identify whether the remote computing session is authenticated. In some examples, the computing system may authenticate the remote computing session at step 818. In some examples, the computing system may identify whether the remote computing session was previously authenticated. Based on identifying that the remote computing session is not authenticated or based on identifying that authentication is not required, the computing system may end the method depicted in FIG. 8. Based on identifying that the remote computing session is authenticated, the computing system may proceed to step 820. At step 820, the computing system may output a display. For example, the computing system may output a virtual desktop to the client device.

The following paragraphs (M1) through (M11) describe examples of methods that may be implemented in accordance with the present disclosure.

(M1) A method comprising: at a first device comprising one or more processors and memory: receiving, via a second device, a request to prelaunch a remote computing session; receiving a placeholder session file for the remote computing session; initiating, using a launch service application, a prelaunch session corresponding to the remote computing session; disconnecting the prelaunch session; identifying that a trigger condition for establishing the remote computing session has been satisfied; and establishing, for a client device and based on the prelaunch session, the remote computing session.

(M2) A method may be performed as described in paragraph (M1), further comprising generating, based on stored user information, a local user context; initiating, based on the local user context, a utility remote computing session using the launch service application and a loopback connection to the first device; downloading, via the utility remote computing session, user information corresponding to the second device; and updating, based on the user information corresponding to the second device, the placeholder session file, wherein initiating the prelaunch session is based on the utility remote computing session.

(M3) A method may be performed as described in any of paragraphs (M1) through (M2), wherein the local user context comprises spoofed client device information.

(M4) A method may be performed as described in any of paragraphs (M1) through (M3), further comprising outputting, to the client device and based on establishing the remote computing session, a remote desktop display.

(M5) A method may be performed as described in any of paragraphs (M1) through (M4), further comprising authenticating, after disconnecting the prelaunch session and prior to establishing the remote computing session, the client device.

(M6) A method may be performed as described in any of paragraphs (M1) through (M5), wherein the launch service application is configured to initiate the prelaunch session based on user information corresponding to the second device.

(M7) A method may be performed as described in any of paragraphs (M1) through (M6), wherein the launch service application is configured to initiate the prelaunch session based on the placeholder session file.

(M8) A method may be performed as described in any of paragraphs (M1) through (M7), wherein initiating the prelaunch session comprises loading one or more profiles corresponding to a user of the second device.

(M9) A method may be performed as described in any of paragraphs (M1) through (M8), wherein initiating the prelaunch session comprises prelaunching one or more applications identified by the request to prelaunch the remote computing session.

(M10) A method may be performed as described in any of paragraphs (M1) through (M9), wherein identifying that the trigger condition for establishing the remote computing session has been satisfied comprises identifying that a predetermined amount of time after initiating the prelaunch session has been met or exceeded.

(M11) method may be performed as described in any of paragraphs (M1) through (M10), wherein identifying that the trigger condition for establishing the remote computing session has been satisfied comprises identifying that the second device is located within a threshold proximity of the client device.

The following paragraphs (A1) through (A8) describe examples of computing systems that may be implemented in accordance with the present disclosure.

(A1) A computing system comprising one or more processors; and memory storing computer executable instructions that, when executed by the one or more processors, cause the computing system to: receive, via a computing device, a request to prelaunch a remote computing session; receive a placeholder session file for the remote computing session; initiate, using a launch service application, a prelaunch session corresponding to the remote computing session; disconnect the prelaunch session; identify that a trigger condition for establishing the remote computing session has been satisfied; and establish, for a client device and based on the prelaunch session, the remote computing session.

(A2) A computing system as described in paragraph (A1), wherein the memory stores additional computer executable instructions, when executed by the one or more processors, cause the computing system to: generate, based on stored user information, a local user context; initiate, based on the local user context, a utility remote computing session using the launch service application and a loopback connection to the computing device; download, via the utility remote computing session, user information corresponding to the computing device; update, based on the user information corresponding to the computing device, the placeholder session file, wherein initiating the prelaunch session is based on the utility remote computing session.

(A3) A computing system as described in any one of paragraphs (A1) through (A2), wherein the launch service application is configured to initiate the prelaunch session based on user information corresponding to the computing device.

(A4) A computing system as described in any one of paragraphs (A1) through (A3), wherein the launch service application is configured to initiate the prelaunch session based on the placeholder session file.

(A5) A computing system as described in any one of paragraphs (A1) through (A4), wherein initiating the prelaunch session comprises loading one or more profiles corresponding to a user of the computing device.

(A6) A computing system as described in any one of paragraphs (A1) through (A5), wherein initiating the prelaunch session comprises prelaunching one or more applications identified by the request to prelaunch the remote computing session.

(A7) A computing system as described in any one of paragraphs (A1) through (A6) wherein identifying that the trigger condition for establishing the remote computing session has been satisfied comprises identifying that a predetermined amount of time after initiating the prelaunch session has been met or exceeded.

(A8) A computing system as described in any one of paragraphs (A1) through (A7), wherein identifying that the trigger condition for establishing the remote computing session has been satisfied comprises identifying that the computing device is located within a threshold proximity of the client device.

The following paragraph (CRM1) describes an example of computer-readable media that may be implemented in accordance with the present disclosure.

(CRM1) One or more non-transitory computer-readable media storing instructions that, when executed by a computing system comprising at least one processor, a communication interface, and memory, cause the computing system to: receive, via a computing device, a request to prelaunch a remote computing session; receive a placeholder session file for the remote computing session; initiate, using a launch service application, a prelaunch session corresponding to the remote computing session; disconnect the prelaunch session; identify that a trigger condition for establishing the remote computing session has been satisfied; and establish, for a client device and based on the prelaunch session, the remote computing session.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
at a first device comprising one or more processors and memory:
receiving, via a second device, a request to prelaunch a remote computing session;
receiving a placeholder session file for the remote computing session;
initiating, using a launch service application, a prelaunch session corresponding to the remote computing session;
disconnecting the prelaunch session;
identifying that a trigger condition for establishing the remote computing session has been satisfied; and
establishing, for a client device and based on the prelaunch session, the remote computing session.

2. The method of claim 1, further comprising:
generating, based on stored user information, a local user context;
initiating, based on the local user context, a utility remote computing session using the launch service application and a loopback connection to the first device;
downloading, via the utility remote computing session, user information corresponding to the second device; and
updating, based on the user information corresponding to the second device, the placeholder session file,
wherein initiating the prelaunch session is based on the utility remote computing session.

3. The method of claim 2, wherein the local user context comprises spoofed client device information.

4. The method of claim 1, further comprising:
outputting, to the client device and based on establishing the remote computing session, a remote desktop display.

5. The method of claim 1, further comprising:
authenticating, after disconnecting the prelaunch session and prior to establishing the remote computing session, the client device.

6. The method of claim 1, wherein the launch service application is configured to initiate the prelaunch session based on user information corresponding to the second device.

7. The method of claim 1, wherein the launch service application is configured to initiate the prelaunch session based on the placeholder session file.

8. The method of claim 1, wherein initiating the prelaunch session comprises loading one or more profiles corresponding to a user of the second device.

9. The method of claim 1, wherein initiating the prelaunch session comprises prelaunching one or more applications identified by the request to prelaunch the remote computing session.

10. The method of claim 1, wherein identifying that the trigger condition for establishing the remote computing session has been satisfied comprises identifying that a predetermined amount of time after initiating the prelaunch session has been met or exceeded.

11. The method of claim 1, wherein identifying that the trigger condition for establishing the remote computing session has been satisfied comprises identifying that the second device is located within a threshold proximity of the client device.

12. A computing system comprising:
one or more processors; and
memory storing computer executable instructions that, when executed by the one or more processors, cause the computing system to:
receive, via a computing device, a request to prelaunch a remote computing session;
receive a placeholder session file for the remote computing session;
initiate, using a launch service application, a prelaunch session corresponding to the remote computing session;
disconnect the prelaunch session;
identify that a trigger condition for establishing the remote computing session has been satisfied; and
establish, for a client device and based on the prelaunch session, the remote computing session.

13. The computing system of claim 12, wherein the memory stores additional computer executable instructions, when executed by the one or more processors, cause the computing system to:
generate, based on stored user information, a local user context;
initiate, based on the local user context, a utility remote computing session using the launch service application and a loopback connection to the computing system;
download, via the utility remote computing session, user information corresponding to the computing device; and
update, based on the user information corresponding to the computing device, the placeholder session file,
wherein initiating the prelaunch session is based on the utility remote computing session.

14. The computing system of claim 12, wherein the launch service application is configured to initiate the prelaunch session based on user information corresponding to the computing device.

15. The computing system of claim 12, wherein the launch service application is configured to initiate the prelaunch session based on the placeholder session file.

16. The computing system of claim 12, wherein initiating the prelaunch session comprises loading one or more profiles corresponding to a user of the computing device.

17. The computing system of claim 12, wherein initiating the prelaunch session comprises prelaunching one or more applications identified by the request to prelaunch the remote computing session.

18. The computing system of claim 12, wherein identifying that the trigger condition for establishing the remote computing session has been satisfied comprises identifying that a predetermined amount of time after initiating the prelaunch session has been met or exceeded.

19. The computing system of claim 12, wherein identifying that the trigger condition for establishing the remote computing session has been satisfied comprises identifying that the computing device is located within a threshold proximity of the client device.

20. One or more non-transitory computer-readable media storing instructions that, when executed by a computing system comprising at least one processor, a communication interface, and memory, cause the computing system to:
receive, via a computing device, a request to prelaunch a remote computing session;
receive a placeholder session file for the remote computing session;
initiate, using a launch service application, a prelaunch session corresponding to the remote computing session;
disconnect the prelaunch session;
identify that a trigger condition for establishing the remote computing session has been satisfied; and
establish, for a client device and based on the prelaunch session, the remote computing session.
